(19) United States
(12) Patent Application Publication
(10) Pub. No.: US 2003/0141757 A1
(43) Pub. Date: Jul. 31, 2003

(54) Flexible axle for motor vehicle with improved antiroll device

(76) Inventor: Philippe Deletombe, Chalon-sur-Marne (FR)

Correspondence Address: GREENBLUM & BERNSTEIN, P.L.C., 1950 ROLAND CLARKE PLACE, RESTON, VA, 20191, US

(21) Appl. No.: 10/220,238

(22) PCT Filed: Feb. 26, 2001
(86) PCT No.: PCT/FR01/00551

(30) Foreign Application Priority Data
Mar. 2, 2000 (FR) 00/02706

(51) Int. Cl. B60B 37/00

(52) U.S. Cl. 301/127

(57) ABSTRACT

Motor vehicle axle assembly that includes two arms configured to be mounted in an articulated manner to a motor vehicle body. Each of the two arms is coupled to a wheel-bearing knuckle. A crosspiece is coupled to each of the two arms. At least one insert includes at least one elastomer element and at least one bearing. The at least one insert is arranged to at least one of couple at least one end of the cross piece to at least one of the two arms and couple a first part of the cross piece to a second part of the cross piece. This abstract is neither intended to define the invention disclosed in this specification nor intended to limit the scope of the invention in any way.

The invention relates to motor vehicle suspensions.

It relates more particularly to axles with drawn arms, connected by a flexible or semi-rigid crosspiece, one end of each arm supporting a knuckle receiving a wheel, whereas the other end is mounted articulatedly on the body of the vehicle.

The crosspiece must be resistant to bending in order to guide the plane of the wheels in a satisfactory trajectory, by limiting any variation in angular position of the arms with respect to one another, but supple in torsion in order to allow each arm to oscillate.

It is furthermore desirable that the axle carries out an anti-roll function by a means effecting the return of one arm relative to the other to a central position.

EP 0 229 576 describes such a semi-rigid axle obtained by shaping a single metal tube to form the arms and the crosspiece integrally.

However, it is not possible to optimise all the functions demanded of such an axle.

In the international application PCT WO97147486, one of the Applicants proposed a flexible axle comprising a crosspiece and two drawn arms connected by two coupling members manufactured from an elastomer material, which carries out in particular an anti-roll function. These two coupling members, arranged symmetrically each at the end of an arm, are shaped and adapted to effect a torque in torsional reaction to the relative oscillation of one arm with respect to the other. The coupling members, of a predetermined rigidity along the crosspiece, effect guiding in this direction. In order to check the bending of the assembly during operation, the crosspiece comprises two tubes fitted one into another and fixed rigidly to respective arms. The elastomer members are then housed between the two tubes, each close to an arm.

These elastomer members, by virtue of their structure, have suitable resistance to torsion relative to the axis of the crosspiece, in the axial direction thereof as well as in the radial direction so as to optimise both control of the movements of the body and guiding of the wheels.

This technique has been found extremely promising, but the realisation of the crosspiece with two tubes fitted over most of their length contributes in particular to an increase in weight of the non-suspended elements and indirectly to the cost price.

The present invention has just improved the situation.

It relates to an axle, comprising two arms intended to be mounted articulatedly to the body and each equipped with a wheel-bearing knuckle. The axle comprises a crosspiece mounted between these two arms, and the link formed between the two arms by the crosspiece has at least one insert defined by an elastomer element. This element is located, shaped and adapted to effect at least a torsional reaction torque to the oscillations of one arm relative to the other.

According to a general feature of the invention, the insert further has a bearing intended to maintain, in cooperation with the elastomer element, substantially one angular position of each of the two arms relative to the crosspiece, whilst permitting rotation due to the oscillation of the arms, to which rotation the elastomer element reacts torsionally.

The elastomer element thus carries out the anti-roll function of the axle.

According to another advantageous feature of the invention, the bearing in cooperation with the elastomer element effects guiding of the deformation by preventing or limiting deformation transverse to the crosspiece. The bearing thus makes it possible to keep the angular position of each of the arms relative to the crosspiece (in one plane containing this arm and the crosspiece). The cooperation of such a bearing with the elastomer element thus makes it possible to provide an integral crosspiece, or one realised by only partial fitting together of two tubes.

According to a further feature of the invention, the bearing also effects, in cooperation with the elastomer element, guiding of the deformation of the crosspiece by permitting, in certain configurations and in a limited manner, deformation in the longitudinal axis of the crosspiece, which in the case of lightweight semi-rigid axles makes it possible to improve the fatigue-resistance of the axle, in particular the resistance during operation of the fitting of the crosspiece into the arms, as will be seen below.

Further advantages and features of the invention will appear from the following detailed description and from the attached drawings, which show:

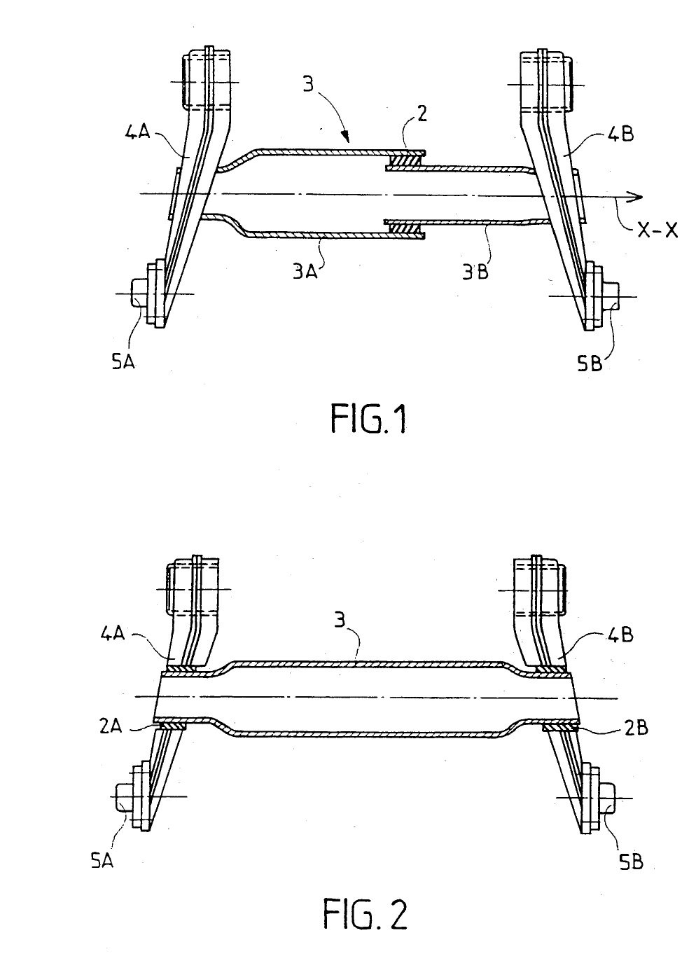

FIG. 1 a partial plan view of an axle according to a first embodiment of the invention;

FIG. 2 part of an axle according to a second embodiment of the invention;

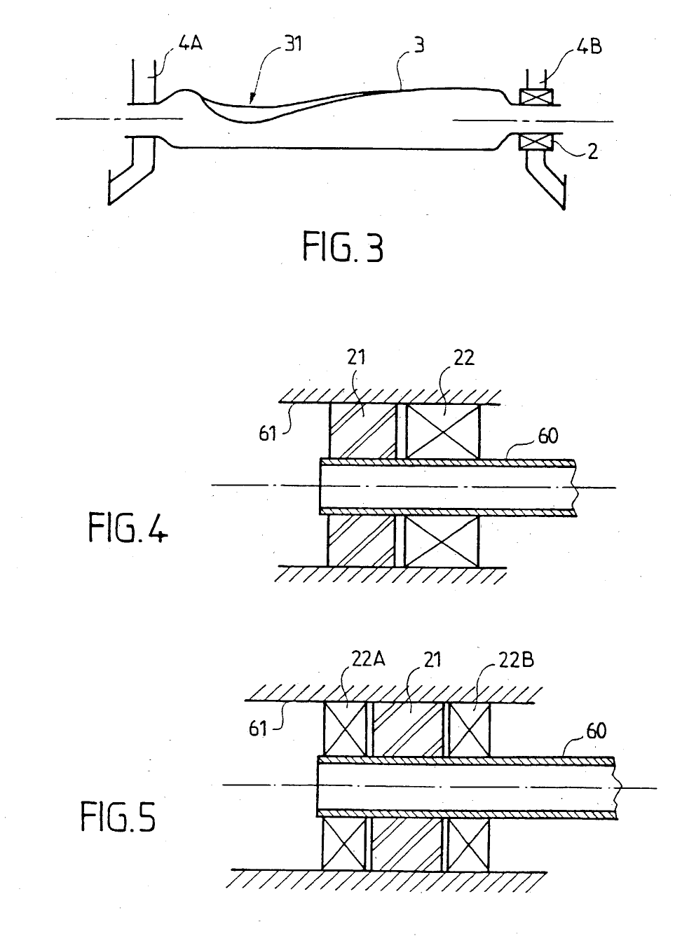

FIG. 3 part of an axle according to a third embodiment of the invention;

FIG. 4 a detailed view of an insert provided in an axle such as shown in one of FIGS. 1, 2 or 3;

FIG. 5 a detailed view of a modified version of the insert shown in FIG. 4;

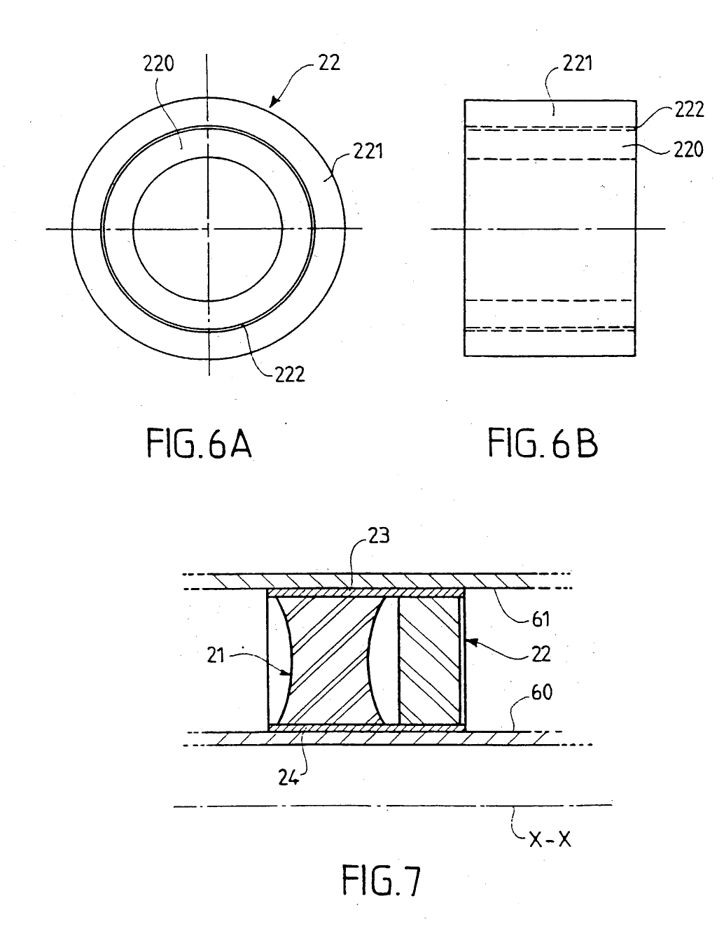

FIGS. 6A and 6B a bearing of the insert in a special embodiment; and

FIG. 7 in part, an integral insert according to an advantageous embodiment.

The detailed description below and the attached drawings are essentially important. They may not only help to clarify the invention, but also contribute to its definition if necessary.

FIG. 1 is referred to first in order to describe an axle intended to be mounted on the body of a motor vehicle.

This axle has a crosspiece 3 connecting two suspension arms 4A and 4B. Each arm 4A bears a knuckle 5A intended to receive a wheel (not shown). The other end of each arm 4A is connected to a shaft (not shown) permitting articulation along an axis of oscillation or pivoting of the arm relative to the body. In the example shown in FIG. 1, the axes of oscillation of the arms are co-linear.

In practice, resilient suspension articulations are provided, which surround each shaft of the above-mentioned type. A particularly advantageous embodiment of these articulations is described in the application WO 97/47486.

In the first embodiment shown in FIG. 1, the crosspiece 3 is formed of two tubes 3A and 3B, partially fitted one in another. The shared length of the two tubes 3A and 3B shows a small part of the length of the crosspiece, typically a tenth of this length. In particular, the tube 3B is fixed rigidly by one end to the arm 4B, whereas the other end is inserted into a first end of the tube 3A, which is coaxial to and of a larger radius than the radius of the tube 3B. The other end of the tube 3A is fixed rigidly to the arm 4A. Fixation of the ends of the tubes 3A and 3B to the arms 4A and 4B may be effected by shrinking on, by crimping, by the fitting of grooves, or by soldering. The axle insert according to the invention is disposed between the respective ends of the tubes 3A and 3B forming the crosspiece 3.

Referring to either of FIGS. 4 and 5, this insert is formed of at least one bearing 22 in association with an element 21 formed from an elastomer material. Preferably, the bearing 22 is located immediately adjacent to the elastomer element 21.

Advantageously, the element 21 is formed by a rubber ring, whose internal and external faces are connected, e.g. by adhesion or the like, to tubular elements 23 and 24 (FIG. 7) such as metal rings or metal muffles.

The deformation behaviour of the element 21 in the axial and radial directions is obtained here by a judicious choice of rubber, cavities or otherwise reinforcements housed in the rubber ring, as well as by the shape of the rubber muffles 23 and 24.

The bearing 22 is in this case a ball bearing, a needle bearing, a cylindrical roller bearing, or a conical roller bearing.

In the example described, the internal wall of the bearing 22 and the inner muffle 24 of the elastomer element 21 are fixed to the external wall 60, e.g. of a tube 3B of the crosspiece. The external wall of the bearing 22 and the outer muffle 23 of the elastomer element 21 are fixed to the internal wall 61, e.g. of another tube 3A of the crosspiece, or else of one of the suspension arms 4A (4B), as will be seen below.

Fixing of the bearing 22 and of the metal muffles of the elastomer element 21 may be effected by any known means such as, for example, a force fit.

In the advantageous embodiment shown in FIG. 7, the outer and/or inner metal muffles have an axial length which exceeds that of the rubber ring, thus making it possible to connect the bearing 22 thereto. The insert is therefore integral and its placing in the crosspiece is easier. Advantageously, the assembly time is considerably reduced and consequently so are the manufacturing costs. To this end, the present invention also has the object of providing an integral insert of the aforesaid type.

In another modification, the rubber ring may be directly fixed to the metal tubes 3A and 3B without the aid of metal .

The bearing 22, of a selected width, has an extremely small inherent radial play. It is disposed at a selected distance from the elastomer ring 21 in order to maintain in cooperation with the latter a substantially constant angular position, according to the pivoting, of one of the arms 4A and 4B relative tot he crosspiece 3 (formed if necessary from the assembly of tubes 3a and 3b).

This angular positioning is to be considered in a plane comprising one arm and the crosspiece.

By carrying out tests on the semi-rigid axles thus conceived, the Applicants have in fact shown that the distance between the bearing and the elastomer ring, for one and the same insert, was an important parameter in maintaining the angular position of the arms relative to the crosspiece. Thus this distance between the bearing and the ring is advantageously selected according to the rigidity of the elastomer ring with a view to optimising this cooperation between the ring and the bearing.

Due to the fact that the angular position of the arms relative to the crosspiece is maintained, any load on one and/or other of the arms capable of varying the orientation of the plane of the wheels induces) bending moments on the crosspiece (if necessary formed of the assembly of tubes 3A and 3B). The section and the material of these tubes are intended to make them resistant to bending.

Thus excellent guiding of the wheels is obtained.

The bearing 22 generally has extremely little inherent play along the large dimension of the crosspiece 3, which thus limits deformation in operation of the crosspiece in the longitudinal direction thereof. The bearing can nevertheless be selected to have more play in this direction, as can be seen below.

The torsional reaction induced by the oscillation of the arms 4A and 4B on the crosspiece 3 is mainly effected here by the elastomer element 21 whose rigidity is selected to effect a torsional reaction torque, the tubes 3A and 3B being virtually resistant to torsion due to their cross-section and their material.

Thus a resistance to torsion and bending is obtained which is at least as satisfactory as that described in WO97/47486, the anti-roll function being effected by the elastomer element of the insert, whereas the function of guiding the wheels is effected by the cooperation between the bearing and the elastomer element of the insert.

The constituent parts of the crosspiece 3 are preferably made of metal, aluminium or an alloy thereof.

Optionally, the constituent parts of the crosspiece 3 are formed from a composite material, comprising a resin charged with reinforcing fibres. The lightness of this material is particularly appropriate when it is desired to minimise the mass of the non-suspended parts of the vehicle.

In a modification of an embodiment with a base of rollers, the bearing 22 may also take the form of two smooth rings 220 and 221 (FIGS. 6A and 6B), inserted one into another. Their contact zone 222 has low friction due to the constituent materials or surface treatments carried out or even the interposition of a lubricant. The smaller ring 220 may also slide into the larger ring 221. These rings may be formed of metal, plastics material, or the like. The internal surface of the ring 220 and the external surface of the ring 221 are fixed rigidly to parts of the axle, such as the crosspiece and/or one or more of the arms.

The external ring 221 may move relative to the internal ring 220 by rotation about the axis X-X of the crosspiece (FIG. 1) and/or by translation along this axis. The reaction to these displacements is effected by the elastomer element 21, which thus cooperates with the bearing 22 in order to restrict translation.

The possible translation of one of the smooth rings relative to the other along this longitudinal axis makes it possible to limit the stress peaks in the casing of the tubes 3A, 3b in the arms 4A, 4B, these peaks being mentioned in the Application WO97/47486.

In another modification, the bearing is formed of a single ring whose internal surface is rigidly fixed to the partition wall 60 (FIGS. 4 and 5). The external surface of such a ring may have adapted anti-friction properties and/or be coated with grease in order to reduce friction with the partition wall 61.

As a modification of the embodiment shown in FIG. 4, and in which the insert 2 has a single bearing 22, an insert can be provided which comprises an elastomer element 21 and two bearings 22A and 22B (FIG. 5). These two bearings are disposed on either side of the elastomer element 21. In this embodiment, the respective widths of the bearings 22A and 22B are selected according to the width of the elastomer element 21 and its rigidity.

FIG. 2 will now be referred to in order to describe an axle according to a second embodiment of the present invention.

In this preferred embodiment, the crosspiece 3 is integral, formed of a single tube, whose ends are connected to the suspension arms 4A and 4B. In the example shown in FIG. 2, the ends of the tube 3 are fitted in respective apertures of the arms 4A and 4B, via respective inserts 2A and 2B, of the type shown in either of FIGS. 4 and 5.

In a modification (FIG. 3) of the embodiment shown in FIG. 2, the integral crosspiece 3 is fixed rigidly and directly to one of the suspension arms 4A by one end. Its other end is connected to the other suspension arm 4B via an insert 2 comprising an elastomer element and at least one bearing.

In this modification, the asymmetry of the reactions to bending stresses to which the crosspiece is subjected may be alleviated by adapting the shape of the integral crosspiece 3 over a portion 31 of its length. Preferably, the tube 3 has been radially flanged in order to have a section which is much more flexible locally, at a given distance and at a sufficient length.

Obviously, the present invention is not restricted to the embodiment described above by way of example. It extends to other modifications.

Obviously, therefore, the suspension arms 4A and 4B may, in a modification of the embodiment shown in FIG. 2, have substantially cylindrical rods both projecting towards the integral crosspiece 3. The ends of these rods are then fitted in the ends of the tube forming the integral crosspiece 3 via respective inserts 2A and 2B.

Obviously, a plurality of elastomer elements 21 can be provided, e.g. two elastomer elements 21 on either side of a single bearing 22 according to the requirements of the particular application.

The above-mentioned rings of elastomer material or rigid material may have a cylindrical, conical or other shape in order to optimise the mechanical behaviour of the ring.

More generally, the insert of the axle according to the invention may have any other shape based on a bearing and an elastomer element, carrying out the same anti-roll function and guiding the arms of the wheels.

Obviously, the term ‘tubes’ used above to describe elements forming parts of the crosspiece referenced 3A, 3B is to be taken in the widest sense. It designates elements having a generally substantially tubular, cylindrical or non-cylindrical shape with, if necessary, variations of diameter or again of shape along their large dimension.

In these embodiments shown, the arms of the wheels oscillate about a common axis parallel to the axis of the crosspiece but remote from this axis.

In other embodiments not shown, the arms of the wheels may oscillate about an axis which merges with the axis of the crosspiece.

The present invention is also applied to any other means or arrangement for attaching wheel arms to the body.

An axle of the type described above can be advantageously applied in the notion of a rear chassis of a coach or truck. The simplicity of this axle makes it possible to adapt to a wide range of vehicles. According to the applications desired, it is possible to select respective widths of the bearing(s), the width and/or rigidity of the elastomer element(s), the rigidity of the tube(s) forming the crosspiece 3, etc..

1. Axle, comprising two arms (4A, 4B) intended to be mounted articulatedly on the body and each equipped with a wheel-bearing knuckle (5A, 5B), as well as a crosspiece (3) which connects these two arms and is equipped with at least one insert (2) comprising an elastomer element (21), which is positioned, shaped and adapted to effect in part at least a torsional torque in reaction to the oscillations of one arm relative to the other, characterised in that the insert further comprises a bearing (22) intended to maintain in cooperation with the elastomer element substantially one angular position of each of the two arms relative to the crosspiece, whilst permitting rotation due to the oscillation of the arms, to which rotation the elastomer element (21) reacts torsionally.

2. Axle according to claim 1, characterised in that the bearing (22) further effects guiding with deformation of the crosspiece (3) by permitting this deformation in a limited manner in the longitudinal direction of the crosspiece.

3. Axle according to either of claims 1 or 2, characterised in that the insert further comprises two imbricated tubular elements (23, 24), between which are housed the elastomer element (21) and the bearing (22) with a view to forming an integral insert.

4. Axle according to one of the preceding claims, characterised in that the bearings (22) are located at a selected distance from the elastomer element (21).

5. Axle according to one of the preceding claims, characterised in that a first insert (2A) comprising an elastomer element and a bearing is mounted between the crosspiece (3) and one of the arms (4A), whereas a second insert (2B), also comprising an elastomer element and a bearing, is mounted between the crosspiece and the other arm (4B).

6. Axle according to one of claims 1 to 4, characterised in that the insert (2) comprising the elastomer element and the bearing is mounted between the crosspiece and one of the arms (4B), whereas the crosspiece (3) is rigidly fixed to the other arm (4A).

7. Axle according to claim 6, characterised in that the crosspiece (3) has a selected variation (31) in its cross-section along its longitudinal axis (X-X).

8. Axle according to one of claims 1 to 4, characterised in that the insert (22) comprising the elastomer element and the bearing is mounted between two constituent parts of the crosspiece (3A, 3B).

9. Axle according to claim 8, characterised in that the two ends of the crosspiece (3A, 3B) are rigidly fixed to the two arms (4A, 4B) respectively.

10. Axle according to one of claims 8 or 9, characterised in that the insert comprises two bearings (22A, 22B) located on either side of the elastomer element (21).

11. Integral insert for an axle according to one of the preceding claims, comprising an elastomer element (21) and a bearing (22), as well as means (23, 24) of keeping the elastomer element (21) and the bearing (22) substantially coaxial and located at a selected distance from one another.
